(19) United States
(12) Patent Application Publication
(10) Pub. No.: US 2006/0080197 A1
(43) Pub. Date: Apr. 13, 2006

(54) Financial account management

(75) Inventor: Alfred L. Chi, Westwood, MA (US)

Correspondence Address: FISH & RICHARDSON PC, P.O. BOX 1022, MINNEAPOLIS, MN, 55440-1022, US

(73) Assignee: eCardWorld.com, LLC, a Massachusetts corporation

(21) Appl. No.: 11/079,916

(22) Filed: Mar. 14, 2005

Related U.S. Application Data
(63) Continuation of application No. 09/549,440, filed on Apr. 14, 2000, now abandoned.
Application No. 09/549,440 is a continuation-in-part of application No. 09/502,147, filed on Feb. 11, 2000, now abandoned.

(51) Int. Cl. G06Q 40/00

(52) U.S. Cl. 705/35

(57) ABSTRACT

A holder of a financial account predefines a virtual account associated with the financial account. The virtual account has an associated limitation on a payment to be made from the financial account. In connection with a transaction, information about the virtual account is provided to a third party. A third party uses the virtual account information to make a request for a payment. Any payment from the financial account that is outside of the limitation associated with the virtual account is prevented. Because only the virtual account information is made available to the third party the risk to the account is limited based on choices made in advance by the user.

This is a continuation-in-part of U.S. patent application Ser. No. 09/502,147 entitled “On-line Personal Financial Account Management,” filed on Feb. 11, 2000, and incorporated by reference.

This invention relates to on-line personal financial account management.

Access to personal financial accounts, including credit card accounts, debit card accounts, checking accounts, savings accounts, and investment accounts, is often governed by an account number, sometimes in combination with a password or personal identification number (PIN). When the holder of the account wants to perform a transaction using one of the accounts, he typically must expose the account number and the password or PIN to third parties. A dishonest third party can use the account number to perform fraudulent or otherwise unauthorized transactions to the full extent of the account balance or limit. For this reason, consumers, for example, are wary of providing credit card account numbers through the Internet to on-line retailers to purchase products.

Credit card fraud is widespread. For example, the Credit Card Management magazine has reported Master Card International's worldwide fraud losses at $462 million in 1996, $466 million in 1997, and $530 million in 1998. With the growing popularity of on-line shoppers using their credit and bank accounts over the Internet, the rate of credit crime is expected to increase significantly. The CRN Business Weekly has reported that e-retailers experience between 15% and 40% fraud rates.

The invention reduces the risk of loss to a user of financial accounts. In general, in one aspect of the invention, a holder of a financial account predefines a virtual account associated with the financial account. The virtual account has an associated limitation on a payment to be made from the financial account. In connection with a transaction, information about the virtual account is provided to a third party. A third party uses the virtual account information to make a request for a payment. Any payment from the financial account that is outside of the limitation associated with the virtual account is prevented. Because only the virtual account information is made available to the third party the risk to the account is limited based on choices made in advance by the user.

Some implementations of the invention are described in the following text.

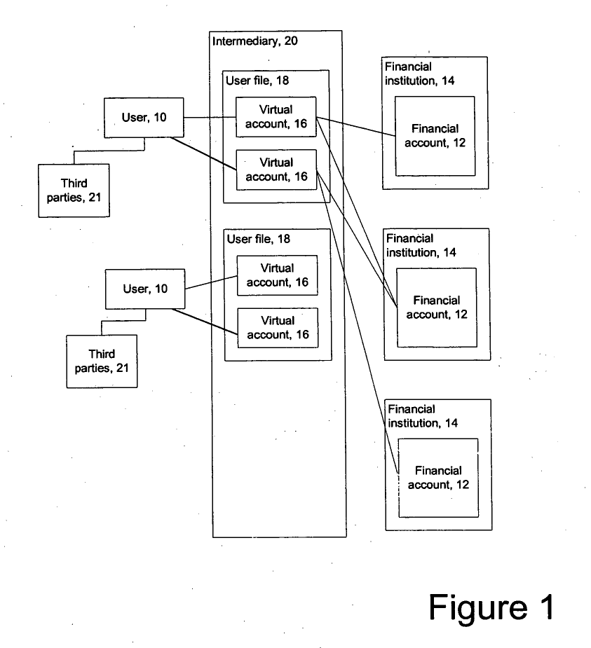

FIGS. 1 through 10 show aspects of implementations of the invention that are explained in the text.

As shown in FIG. 1, a user 10 can manage funds in financial accounts 12 (e.g., credit card accounts, debit card accounts, checking accounts, savings accounts, and investment accounts) that are held by the user in financial institutions 14. The user can manage the funds using so-called virtual accounts 16 that are part of a user file 18, which is maintained on the user's behalf by an intermediary 20. The user can use the virtual account to conduct transactions with third parties 21 that involve funds in the financial accounts. Conducting a transaction requires an active financial account 12 and an issued (validated) virtual account 16. The virtual accounts enable the user, among other things, to limit the risk of theft of funds from the financial accounts in pre-defined ways that depend on the context in which transactions are to occur. The intermediary provides similar services to a large number of users and with respect to a large number of financial accounts.

The following discussion focuses on the example of a consumer using a virtual account to make on-line purchases from an ecommerce retailer. Of course, this is only one example, and other types of parties could use virtual accounts to conduct transactions for other purposes.

To make use of virtual accounts, the consumer first registers with the intermediary either through the intermediary's website 23 or by telephone or mail. In any of the registration methods, the user provides information, described below, that will define the user's file 18 maintained by the intermediary.

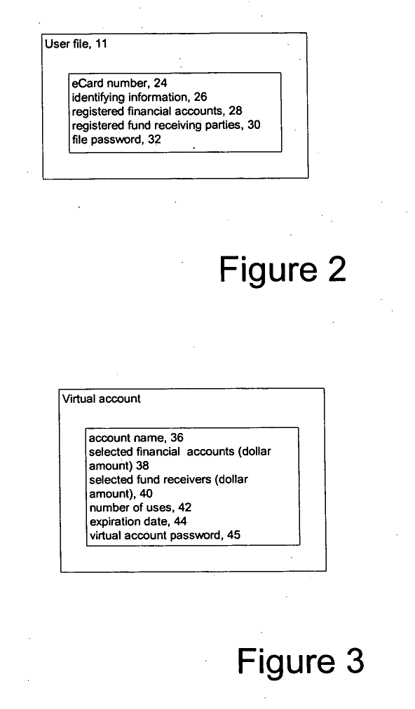

As shown in FIG. 2, the user file 18 includes:
an eCard number 24 that is associated with the user for use in connection with transactions that are to be paid from funds in the accounts; the eCard number can be evidenced on a physical card given to the user for presentation to other parties to the transactions.
a name, address, and other identifying information 26 of the registered user.
a list of registered financial accounts 28 that the user designates to be part of the file; each financial account is identified by the account number, the financial institution, a shorthand name assigned by the user (e.g., “BankBoston Joint Checking Account”), an authorization telephone number for the financial institution.
a list of registered fund receiving parties 30 that the user designates to be part of the file; each account is identified by a name and address.
a file password 32 that enables a user to confirm his authorization to have access to the user file 18.
one or more virtual accounts 34.

The information in the user file can be modified from time to time by the user through the intermediary's website or by telephone or mail. The file password is required as a condition to making a modification.

Once the user is registered, he may manage (create, modify, and delete) one or more virtual accounts 34. The virtual accounts are managed through the intermediary's website or by telephone or mail. Access to create a virtual account requires use of the user's name and file password. Access to modify and delete a virtual account requires use of the virtual account password (mentioned below).

As shown in FIG. 3, each of the virtual accounts 34 in the file includes
a virtual account name 36 (between one and sixteen numbers or letters).
an indication 38 of which registered financial accounts are available for use in the virtual account and a specific dollar limit that is to be available from each of the financial accounts.
an indication 40 of which registered fund receivers are authorized to receive funds in the virtual account and a specific dollar limit that may be paid to each of the receivers.
an indication 42 of the number of occasions on which the virtual account may be used.
an indication 43 of an expiration date of the virtual account.
a virtual account password 45 selected by the user.

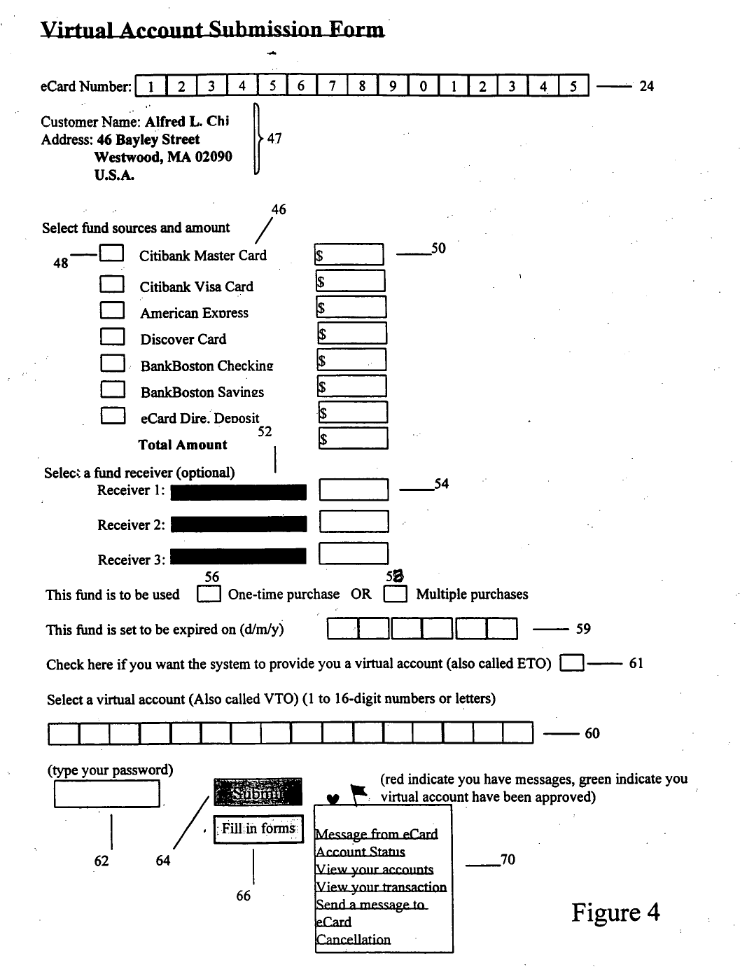

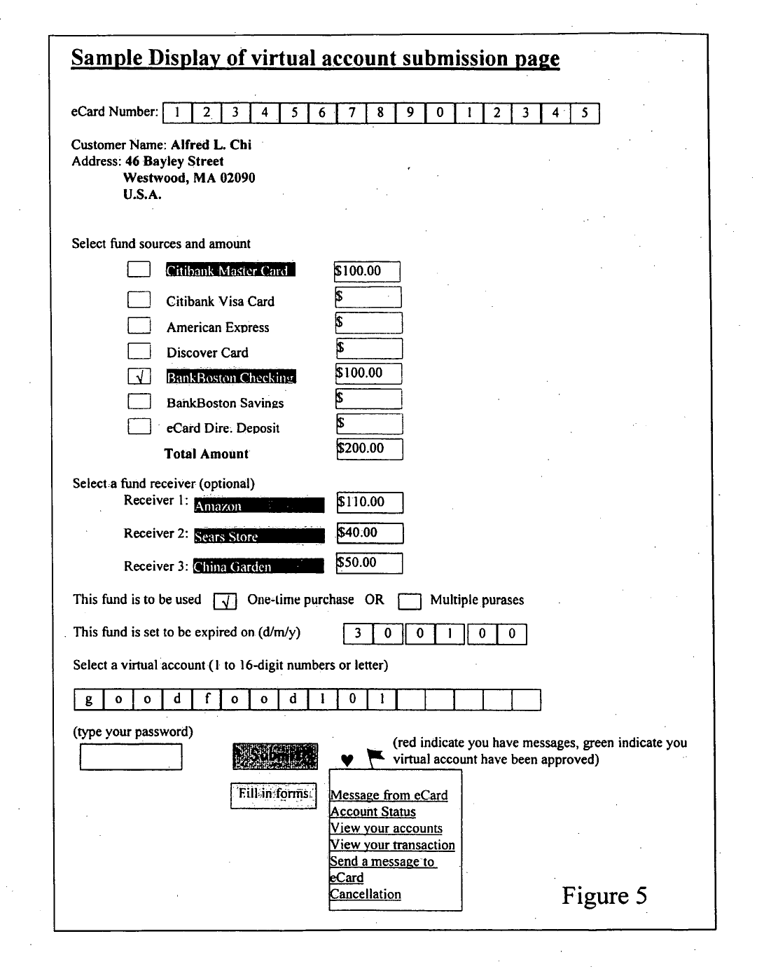

When the virtual account is being managed on-line, one mechanism for controlling the information in the account is a virtual account submission form, for example, the form shown in FIGS. 4 and 5. (FIG. 4 is a blank form and FIG. 5 is an example of a completed form.) The form may be displayed to the user as a web page on the web site hosted by the intermediary. The initially displayed uncompleted form includes the existing eCard number 24 of the user, the customer's name and address 47, and a list of shorthand names of all registered financial accounts 46. Each financial account has a check box 48 and a box 50 to indicate an upper dollar limit on funds that may be drawn from the financial account in connection with the virtual account.

The virtual account form also includes boxes identifying receivers of funds 52 in connection with the virtual account. The receivers may be chosen from among all of the registered receivers using a drop down list. A box 54 next to each receiver shows a maximum limit of dollars that can be paid to the receiver in connection with the virtual account.

Boxes 56, 58 are provided to indicate whether a single or multiple purchases are permitted for the virtual account. A box 59 shows the expiration date of the virtual account.

The virtual account name can be selected by the account holder (user), in which case the virtual account is called a virtual-transaction-order (VTO), or by the account issuer (intermediary) in which case the virtual account is called an express-transaction-order (ETO). A box 60 contains the virtual account name (VTO) selected by the user. A check box 61 is provided to select an ETO in which case the user does not select the name. A box 62 provides a place to type the virtual account password. A submit button 64 enables a registered user to submit a new or modified form for processing to create a new or modified virtual account. After clicking the submit button 64, if the user selected an ETO by checking the box 61, the user is informed of the ETO (one to ten numbers or letters) on an ETO information screen (not shown) and told to record the ETO and keep it in a safe place.

By clicking on the fill-in forms button 66 the user's name, address, e-card number and virtual card number are automatically transferred into the appropriate boxes in the shopping cart page of a merchant at which a purchase is being made.

Links 70 enable the user to perform other functions including reading a message from the intermediary, reviewing the status of his file, viewing virtual accounts, viewing transactions performed using virtual accounts, sending a message to the intermediary, and canceling the account submission.

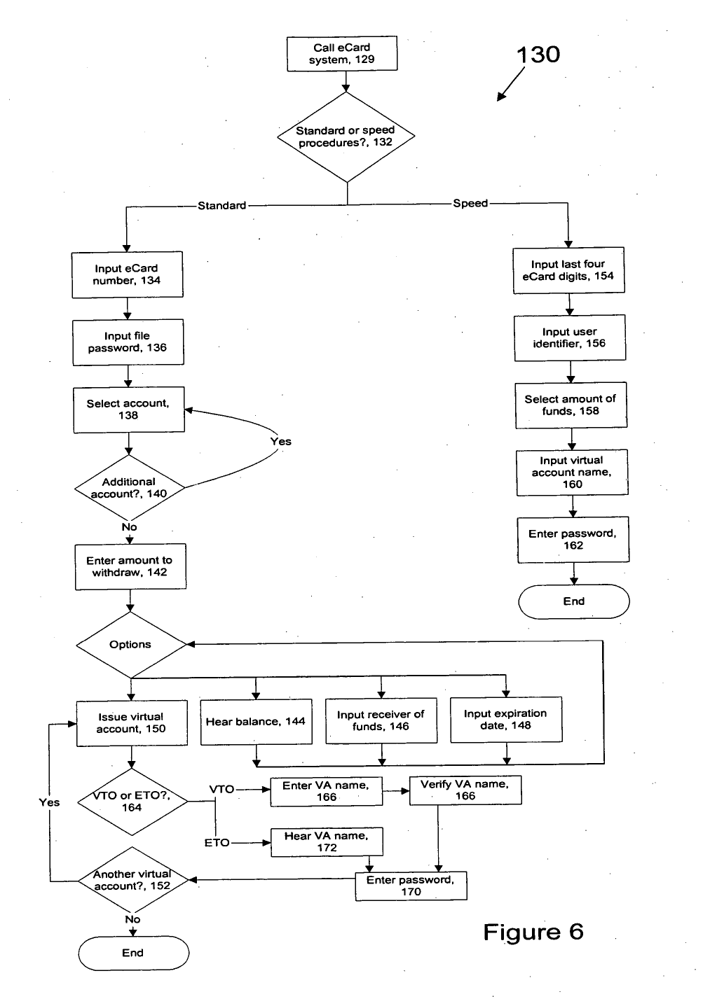

When the virtual account is being managed by telephone, one mechanism for controlling the information in the account is a telephone access system that uses, for example, a method 130 shown in FIG. 6. The method begins when a user calls 129 a phone number of an eCard system. The eCard system is an automated telephone system that uses recorded voice prompts and touch tone (dual tone multi-frequency) responses, but alternatively the communication can be by live conversation between the user and a customer service representative. Once the user has telephone access to the eCard system, in the case of automated response, the user chooses between standard procedures 131 and speed procedures 133 by pressing one key for “standard” or another key for “speed,” the keys being verbally identified to the user (132). In other examples, the user may not be offered a choice.

In either the standard procedure or the speed procedure, the user may press a predefined one-key sequence or two-key sequence, identified when the user accesses the system, at any time during the call to have the option of canceling his previous entry and/or canceling the transaction.

In the standard procedure, the user enters an eCard number (134) and a user file password (big key) (136) using his telephone keypad. Once the eCard number and the user file password are verified as accurate, the user selects a financial account for which he wants to earmark funds for allocation to a virtual account (138). For purposes of selecting an account, the system gives the user with a number of account options, such as “enter one for Visa, enter two for MasterCard, three for Discover, or zero for another account.” Pressing zero in this example could provide the user with another automated list of account choices and/or the user may be prompted to verbally identify the desired account after hearing a “beep.” After selecting an account, the system 130 inquires if the user wants to identify another account from which funds are to be allocated to virtual accounts (140). If so, the user is directed back to item 138. If not, the system proceeds. For each selected financial account, the user enters the amount to allocate from that financial account (an upper dollar limit) (142) by, for example, pressing “2-0-0-0-0” for $200.00.

The user may then be presented with account options, each of which the user can select by pressing an identified key. Each option can be selected any number of times, including multiple times. One option includes hearing the total balance of available funds in the user's eCard account (144). Another option includes inputting the designated receiver of the selected eCard funds by clearly stating the name and/or phone number of the fund receiver after hearing a “beep” (146). Alternatively, the system could present the user with a number of fund receiver options and a key to press to verbally identify a fund receiver in a procedure similar to selecting an account. Another option includes entering the expiration date of the account (148) by, for example, pressing “0-3-2-0-2-0-0-0” for Mar. 20, 2000.

Another option is issuing a virtual account (150). Issuing the virtual account finishes the transaction. The user chooses between entering a virtual account name (VTO) or being provided with one (ETO) (164). For a VTO, the user enters the virtual account name using the telephone keypad or by verbally identifying the name after hearing a “beep” (166). For accuracy and added security, the user is prompted to reenter the virtual account name (168). The user is also prompted to enter his virtual account password (small key) (170). For an ETO, the user verbally hears the virtual account name (172) and is told to record the ETO and keep the ETO in a safe place. The ETO may be repeated to ensure that the user accurately records it. The user also enters a virtual account password (170). Once the virtual account is created, the user may choose to create another virtual account (152). If so, the steps are the same ones shown beginning at item 136. If not, the system terminates the call, possibly first informing the user how to again access item 132 or other item in the system.

If the user chooses the speed procedure, the user enters the last four digits of his eCard number (154) and the last four digits of his social security number (156). Instead of entering part of a social security number, the system 130 could ask for another unique user identifier such as the file password. The user then selects the amount of the funds he desires to allocate from a recorded list (158), such as “press one for $200.00, two for $500.00, and three for $1000.00.” The user also enters the virtual account name (160) and the virtual account password (small key) (162). The speed procedure may instead offer the user a choice between a VTO or an ETO or automatically provide the user with an ETO. After the password is verified, the virtual account is created. Having issued the account, the system 130 terminates the call, possibly first informing the user how to again access item 132.

Whenever a new or modified virtual account is created, the intermediary verifies with the financial institutions that maintain the accounts involved, that the amounts indicated for those financial accounts in the virtual account are available from the financial accounts. The intermediary also arranges for the financial institutions to reserve those amounts against the possible use in the virtual account. Once the amounts have been verified and reserved, the intermediary confirms the validity of the new or modified virtual account to the user.

Before virtual accounts are set up and used, the intermediary pre-arranges with ecommerce vendors to accept the eCard number and virtual account numbers from users who are registered with the intermediary. The ecommerce vendors may include on their shopping cart or similar web pages the ability for the user to indicate that he is an eCard holder. Space also may be provided for the user to enter the eCard and virtual account numbers. Alternatively, the ecommerce vendor may accept the eCard and virtual account information in a box provided for alternative payment arrangements other than commonly available credit cards such as Visa.

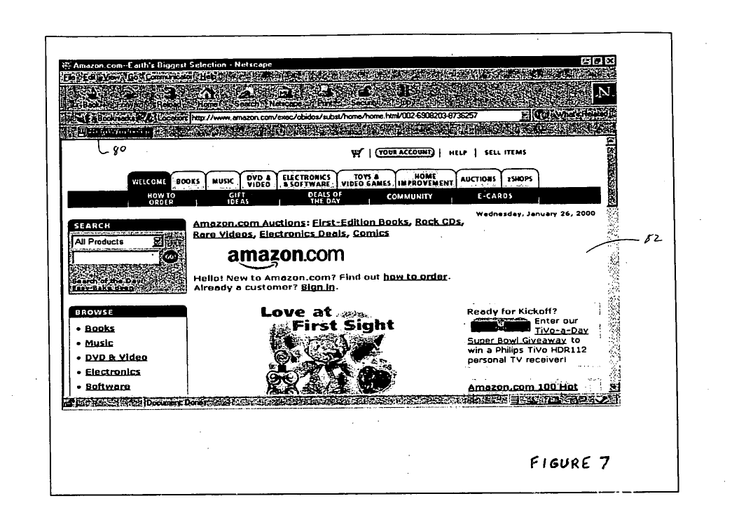

As seen in FIG. 7, for interacting with the intermediary on the World Wide Web, a registered user can install a linking icon 80 in a tool bar of his browser. The toolbar, and therefore the icon remains, active without regard to the web sites being visited in the main window 82 of the browser. If a user were visiting the amazon.com site, for example, and wished to manage a virtual account, say for the purpose of configuring it for making a purchase from amazon.com, he would click on the icon 80, which would open a window for a user to log onto the web site of the intermediary.

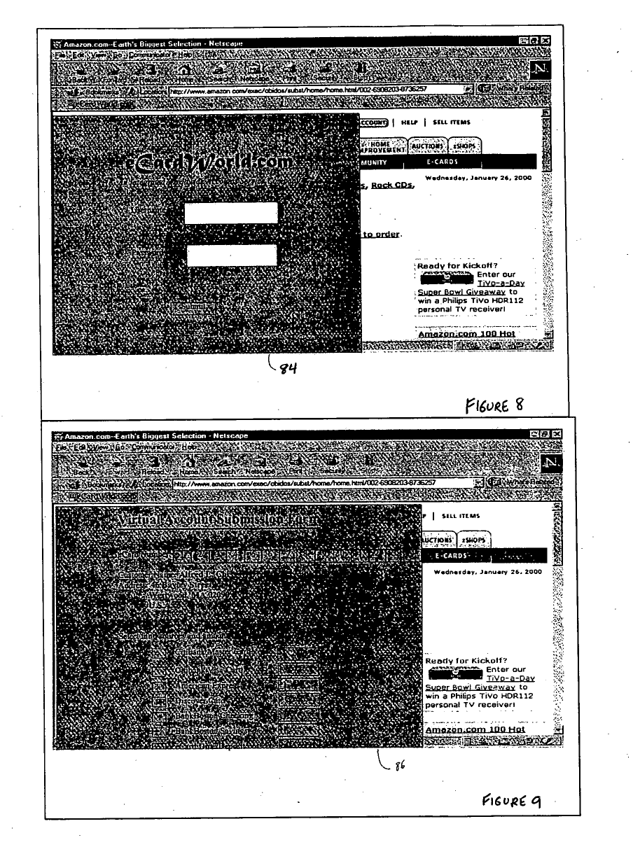

The window 84, shown in FIG. 8, includes a box for a user name and a user password (which is the file password mentioned earlier). After typing his name and the password and clicking the submit button, the server of the intermediary's web site would verify the password information. Then the server would display the virtual account submission form 86 part of which is shown in FIG. 9.

Purchases can be made either electronically or in person at stores.

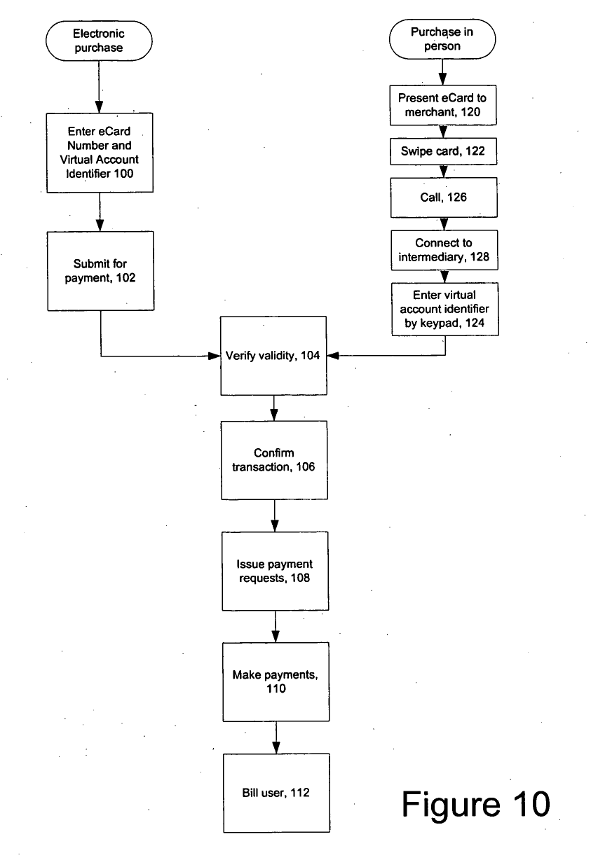

As seen in FIG. 10, when the vendor is asked for credit card information, the user enters his eCard number and his virtual account identifier (100). Upon confirming the order, the web vendor's server automatically submits the eCard and virtual account information to the intermediary's server for payment (102). The intermediary's server confirms that the eCard and virtual account are valid and that the vendor's identity and the payment amount are within the limits specified in the virtual account (104), including the limits with respect to amount, time, and number of transactions (otherwise, the transaction is refused.) If the limits have not been violated, then the intermediary confirms the transaction back to the vendor (106) and pays the amounts to the vendor. The intermediary server divides the charge amount among the financial accounts for that virtual account and issues payment requests to the financial institutions that maintain those accounts (108). The payments are made in the usual course (110) and the user is billed by the financial institution (112). If the intermediary has a pre-arrangement with the financial institution, the intermediary may be able to interact with the financial institution using the eCard number directly. Otherwise, the intermediary uses the account number (for example, the credit card number) established by the financial institution.

In the case of a purchase in person at a store, the user presents the eCard to the merchant (120). The merchant swipes the card on a reader (122). A call is then automatically made to a phone number provided on the magnetic stripe of the eCard (126). The call is connected to the intermediary (128). The user enters the desired virtual account identifier on a keypad (124). From that point, the steps are the same as the ones shown beginning with item 104.

A user may distribute virtual accounts to trusted individuals in a manner that would control the amounts that the trusted individuals could spend from the financial accounts. For example, a parent could provide a virtual account to a child for use on at a college bookstore. In effect, the individual can create any number of specially defined virtual accounts using his financial accounts as the sources of funds, with strict limits on the payments that may be made from the financial accounts, and without concern that the full amounts or limits of the financial accounts would be at risk of fraud.

The intermediary may also provide virtual deposit accounts for users that could earn the same interest as bank accounts. The user would deposit the money into a virtual deposit account and the intermediary would in turn deposit the money into a financial account chosen by the user.

Bill paying services can also be provided by the intermediary to enable the users to pay bills automatically and electronically from the financial accounts at times and in accordance with limitations defined by the user.

Among the advantages of the invention are one or more of the following:

A highly secure, flexible, and reliable system is provided to manage various personal accounts on-line. Fraud is deterred and the credibility of payments is increased for retailer industries, especially e-retailers. Losses to creditors and individual cardholders are also reduced. The system can be used to generate to generate one-time-valid virtual accounts for on-line purchases without worrying about stolen account numbers, fraud, hidden costs, and wrongful charges.

The risk of loss from the financial accounts is reduced to the amount of the transactions authorized by the virtual accounts and is distributed among the virtual accounts. Even if a virtual account number were stolen, the enforcement role played by the intermediary would assure that the loss would not exceed the amount authorized in the virtual account. The user would not need to use or release to vendors any of his financial account numbers. The user can consolidate transactions for all of his financial accounts in one intermediary file and manage them all using virtual accounts.

Other implementations are within the scope of the following claims. For example, other kinds of limitations can be defined in the virtual accounts and enforced by the intermediary.

1. A method comprising
enabling a holder of a financial account to predefine a virtual account associated with the financial account, the virtual account having an associated limitation on a payment to be made from the financial account,
in connection with a transaction, providing information about the virtual account to a third party, and
in response to a request made by the third party for payment using the virtual account information, preventing any payment from the financial account that is outside of the limitation associated with the virtual account.

2. The method of claim 1 in which the limitation of the virtual account comprises a restriction on the identity of the third party to whom the payment is made.

3. The method of claim 1 in which the limitation of the virtual account comprises a restriction on the amount of the payment that may be made.

4. The method of claim 1 in which the limitation of the virtual account comprises an expiration date.

5. The method of claim 1 in which the limitation of the virtual account comprises a restriction on the number of times payments can be made.

6. The method of claim 1 in which the information about the virtual account includes a virtual account identifier.

7. The method of claim 1 in which the financial account comprises a credit card.

8. The method of claim 1 in which the financial account and the virtual account are maintained by different entities.

9. The method of claim 1 in which there are multiple financial accounts and the virtual account has associated limitations on the payments to be made from each of the financial accounts.

10. The method of claim 7 in which there are multiple third parties and the virtual account has associated limitations on the payments to be made to each of the third parties.

11. The method of claim 6 further comprising
enabling the holder to present the virtual account identifier to the third party electronically.

12. The method of claim 6 in which the virtual account identifier comprises between one and sixteen letters or numbers.

13. The method of claim 1 in which there are multiple virtual accounts.

14. The method of claim 13 in which two of the virtual accounts are associated with one of the financial accounts.

15. The method of claim 1 further comprising
enabling the holder to predefine the virtual account using an electronic user interface.

16. The method of claim 1 further comprising
enabling the holder to add, delete, and modify the virtual account.

17. The method of claim 1 in which the virtual account has an associated password and the holder is prevented from viewing, deleting, or modifying the virtual account except upon presentation of the password.

18. The method of claim 1 in which
the request for payment is made in connection with a purchase by the holder from the third party, the request for payment is made to an intermediary party that maintains the virtual account on behalf of the holder, and the intermediary verifies the availability of the payment from the from financial account before authorizing the payment request.

19. The method of claim 1 in which
the holder has access to the virtual account through a web browser.

20. The method of claim 19 in which
the holder has access through an icon displayed on a tool bar of a web browser.

21. The method of claim 1 in which
the holder has access to the virtual account through a web site of an intermediary party.

22. The method of claim 1 in which
the holder has access to the virtual account through a telephone.

23. A method comprising
enabling a holder of a financial account to set two different arbitrary predefined limits on payments that are permissible to make from the financial account, each of the limits being associated with a context in which a transaction may occur, and
blocking a payment from the financial account that would violate either of the different arbitrary predefined limits, depending on the context of the transaction in which the payment is to be made.

24. The method of claim 23 in which the payment is blocked by an intermediary other than a financial institution that maintains the financial account.

25. The method of claim 23 in which the holder can set the predefined limits using a telephone.

26. The method of claim 1 in which the predefining includes the holder presenting a virtual account identifier for the virtual account.

27. The method of claim 1 in which the predefining includes the holder receiving a virtual account identifier for the virtual account.

28. A method comprising
maintaining a digitally stored user file for an individual who holds financial accounts, the user file identifying virtual accounts that set limits on permissible payments to be made from the financial account to specified receivers of the payments, and
processing requests by possible receivers of payments from the financial accounts by blocking requests that violate the limits.

29. A storage medium bearing a program capable of configuring a machine to
enable a holder of a financial account to predefine a virtual account associated with the financial account, the virtual account having an associated limitation on a payment to be made from the financial account,
in connection with a transaction, provide information about the virtual account to a third party, and
in response to a request made by the third party for payment using the virtual account information, prevent any payment from the financial account that is outside of the limitation associated with the virtual account.

30. A database of digitally stored information capable of enabling a machine to
identify virtual account information associated with a financial account, and
in response to a request made by a third party for payment using the virtual account information, identify limitations on payments from the financial account that are associated with the virtual account information.

31. A website that enables a user of a browser to
register as a user of financial account management services, and
manage virtual accounts associated with financial accounts, the virtual accounts defining limitations on payments that can be made from the financial accounts.

32. A method comprising
a first party giving to a second party a file identifier identifying the first party's file with an intermediary party and a virtual account identifier identifying a virtual account maintained by the intermediary party on behalf of the first party, and
blocking the second party from obtaining payment of funds from a financial account of the first party if the payment would violate limits defined in the virtual account.

33. A method comprising
enabling a holder of a financial account to get access to a virtual account management system using a telephone, and
after access is obtained, permitting the holder to manage a virtual account associated with the financial account using the telephone.

34. The method of claim 33 in which the virtual account has an associated password and the holder is prevented from managing the virtual account except on presentation of the password.

35. The method of claim 33 in which managing the virtual account includes managing limits on the virtual account.

36. The method of claim 35 in which managing the virtual account includes managing limits on multiple virtual accounts associated with the holder in a single telephone call.

37. The method of claim 35 in which the limits include restrictions on payments that may be made from the virtual account to one or more third parties.

38. The method of claim 35 in which the limits include an expiration date of the virtual account.

39. The method of claim 35 in which the limits include restrictions on the identities of one or more third parties authorized to receive payments from the virtual account.

40. The method of claim 35 in which the limits include identities of one or more financial accounts associated with the virtual account.

41. A method comprising
in connection with a proposed financial transaction, determining whether the transaction conforms to predefined limitations of a virtual account associated with an active financial account that is a source of finds for the proposed financial transaction, and
validating the proposed financial transaction only if the limitations are met.

42. Apparatus comprising
a virtual financial account that is associated with an active financial account, the active financial account being a source of funds for financial transactions, the virtual financial account defining limitations on uses of funds in the active financial account that can be tested against characteristics of a proposed financial transaction to determine whether or not to validate the proposed financial transaction.
